(19) United States
(12) Patent Application Publication
(10) Pub. No.: US 2012/0170256 A1
(43) Pub. Date: Jul. 5, 2012

(54) CRYOSTAT HAVING AN ILLUMINATION DEVICE

(75) Inventor: Claudia Dorenkamp, Muhlhausen (DE)

(73) Assignee: Leica Biosystems Nussloch GmbH, Nussloch (DE)

(21) Appl. No.: 13/342,327

(22) Filed: Jan. 3, 2012

(30) Foreign Application Priority Data
Jan. 4, 2011 (DE) 10 2011 002 443.3

(51) Int. Cl. F25B 19/00; F21V 33/00

(52) U.S. Cl. 362/154; 62/51.1

(57) ABSTRACT

The present invention relaters to a cryostat (1) having a cryostat chamber (2) containing a microtome (3) for cutting frozen specimens, and further containing an illumination device (4) for illuminating the cryostat chamber (2); the illumination device (4) providing safelight illumination.

### CROSS REFERENCE TO RELATED APPLICATIONS

This application claims priority of German patent application number 10 2011 002 443.3 filed Jan. 4, 2011, the entire disclosure of which is incorporated by reference herein.

### FIELD OF THE INVENTION

The present invention relates to a cryostat having an illumination device in the cryostat chamber, and to a method for illuminating a cryostat chamber.

### BACKGROUND OF THE INVENTION

The present invention is directed to the field of frozen section microautoradiography. In this method, which is used, for example, in pharmaceutical development, radioactively labeled tissue sections are picked up on a slide coated with a suitable photographic emulsion, exposed and later developed. Conventional cryostats, such as are described, for example, in DE 103 18 026 B4, have the problem that the photographic emulsion becomes useless when it is exposed to the cryostat illumination. In order to remedy this problem, the cryostat illumination must be turned off during frozen section microautoradiography. However, this impairs the whole process because of the poor light conditions. In addition, there is also an enormous risk of the user being injured by, for example, the microtome in the cryostat.

The paper entitled “Methods for Brain Autoradiography”, Physiology and Behavior, Vol. 11 (1973), pp. 265-267, proposes to cover the cryostat illumination. The work area is illuminated using light reflected from the blade of the microtome, so that the cut specimen appears dark against the blade. This illumination is also not sufficient.

German Utility Model DE 203 21 622 U1 describes a cryostat having a white-light LED illumination device.

In view of the above, it is desirable to provide a cryostat and a method for illuminating a cryostat which are suitable, in particular, for use in frozen section microautoradiography.

### SUMMARY OF THE INVENTION

According to the present invention, there are provided a cryostat having an illumination device and an illumination method.

An essential feature of the present invention is to provide safelight illumination in a cryostat. To this end, an illumination device disposed in the cryostat chamber emits only light to which the photosensitive element used is not sensitive; i.e., it emits only light of certain wavelength(s) and/or color temperature. This makes it possible to illuminate the interior of the cryostat even in autoradiography applications, so that the user encounters an illuminated work field and the risk of injury is reduced. The entire process is simplified and speeded up.

The wavelength emitted by the illumination device is adapted to the photosensitive element used, which is usually a film or a slide coated with photographic emulsion. Light which is suitable for this purpose is in the range of, for example, from light orange to dark brown; i.e., in a selected range of wavelengths (typically above 500 nm). Typically, the light is substantially monochromatic or covers a certain wavelength range.

In a preferred embodiment of the present invention, the wavelength (in the case of monochromatic light) or the wavelength range and/or the color temperature of the illumination device are discretely or continuously selectable. The illumination device may include a plurality of light sources, preferably LEDs, of different wavelength(s) or color temperature, respectively, which can be controlled individually or in groups. The user may then select the wavelength(s) or color temperature, respectively, using a suitable adjusting element, such as a switch.

Conveniently, the illumination device includes a least one LED. LEDs allow for a compact design, keep heat emission at very low levels, and permit effective cleaning and disinfection. In addition, LEDs are easy to protect from water spray because of their physical shape.

In an embodiment of the present invention, a plurality of LEDs are grouped together into an illumination module, thereby achieving increased luminance with a compact design. This also makes it very easy to protect the electrical contacts of the LEDs from moisture or water spray. Moreover, the illumination modules can be easily replaced, for example, to change the wavelength and/or color temperature of the illumination, for example, when a different photosensitive element is used. To this end, it is convenient to provide the illumination module with a housing having a plug connector for power supply. This allows the illumination module to be replaceably mounted in the cryostat chamber by way of the plug connector. Thus, single or multiple illumination modules can be replaceably mounted, as needed, in prepared plug receptacles in the cryostat chamber.

Further advantages and embodiments of the present invention will become apparent from the description and the accompanying drawings.

It will be understood that the aforementioned features and those described below can be used not only in the specified combinations, but also in other combinations or alone without departing from the scope of the present invention.

### BRIEF DESCRIPTION OF THE DRAWING VIEWS

The present invention is schematically illustrated in the drawings using an exemplary embodiment, and will be described below in detail with reference to the drawings.

FIG. 1 is a schematic perspective view of a preferred embodiment of a cryostat according to the present invention;

FIG. 2 is a cross-sectional view through an illumination module;

FIG. 3 is a top view of an illumination module; and

FIG. 4 is a top view of the cryostat of FIG. 1.

### DETAILED DESCRIPTION OF THE INVENTION

Referring to FIG. 1, there is shown a cryostat 1 having a cryostat chamber 2, in which is provided an illumination device 4 including a plurality of illumination modules 6. Cryostat chamber 2 can be opened and closed by a movable cover 17. Illumination modules 6 are electrically connected by wires 14 to circuit means 10, and by a wire 15 to a power supply 9. Circuit means 10 allows switching and/or dimming of individual or all illumination modules 6.

Also mounted on cryostat 1 is a switch 11 which detects the opening and closing of cover 17 of cryostat chamber 2. Switch 11 is likewise connected by a wire (not shown) to the circuit means. By means of switch 11, single and/or multiple illumination modules 6 can be automatically switched and/or dimmed when cover 17 of cryostat chamber 2 is opened or closed. Typically, illumination of the interior is only needed when the cover is open. Thus, provision may be made for illumination device 4 to be turned off or at least dimmed as the cover is closed.

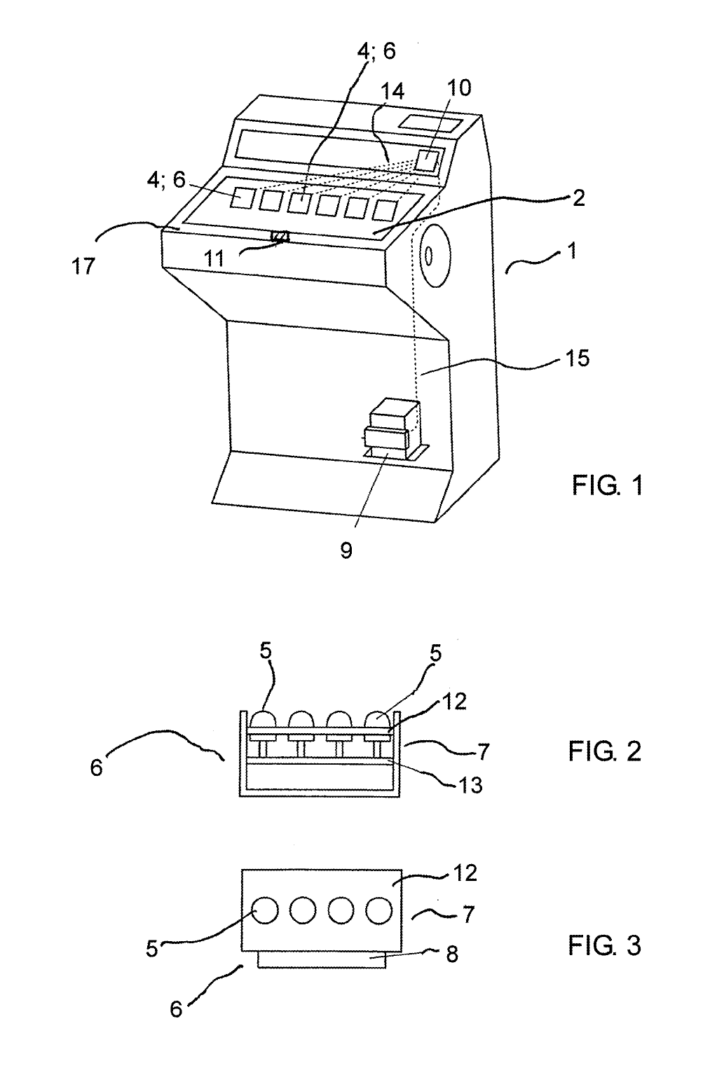

Referring to FIG. 2, there is shown a cross-section through an illumination module 6 having a housing 7 and individual LEDs 5 mounted on a circuit board 13. Conveniently, circuit board 13 and the electrical contacts of LEDs 5 are sealed from external influences by a water spray shield 12 provided in the housing.

Turning now to FIG. 3, there is shown a top view depicting illumination module 6 together with a plug connector 8 disposed on the side of housing 7. Illumination module 6 can be both powered and mounted in cryostat chamber 2 via plug connector 8. This allows illumination modules 6 to be easily replaced, for example, when defective or when other wavelengths or color temperatures are needed.

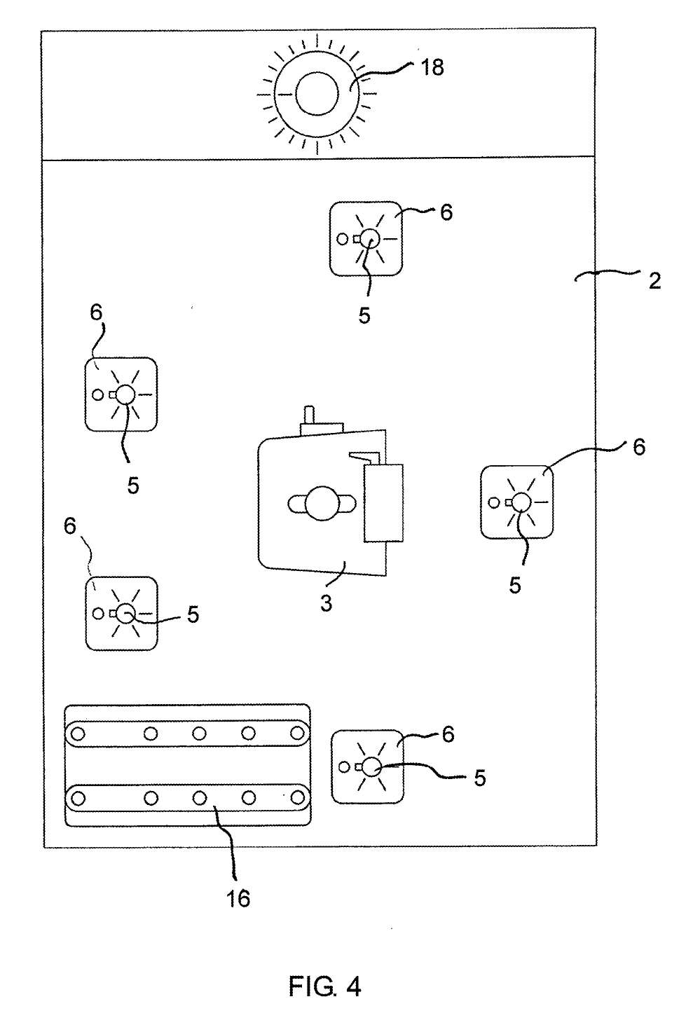

Referring to FIG. 4, there is shown a top view depicting cryostat chamber 2 and microtome 3 disposed centrally therein, as well as illumination modules 6 arranged around microtome 3. This arrangement provides uniform illumination of all areas within cryostat 1. Cryostat chamber 2 contains, in addition to microtome 3, a freezing bar 16 for rapid freezing of specimens and for storing multiple specimen holders. A separate illumination module 6 is provided for illuminating freezing bar 16.

In an embodiment of the present invention, illumination device 4 is adapted to provide safelight illumination. To this end, advantageously, the color temperature and/or the wavelength range or the wavelength (in the case of monochromatic light) are selectable via circuit means 10, which is provided with, for example, a rotary knob 18 (see FIG. 4) for this purpose. Illumination device 4 may include a plurality of identical illumination modules 6 each having different LEDs 5 and/or a plurality of different illumination modules 6 each having identical LEDs 5. This allows the wavelength and/or color temperature of the emitted light to be changed by controlling illumination device 4 accordingly.

The available wavelengths emitted by the illumination device 4 may be restricted, wherein all wavelengths of the light emitted by the illumination device 4 are greater than 500 nm. For example, all wavelengths of the light emitted by the illumination device 4 may be in a range from 500 nm through 550 nm. Alternatively, all wavelengths of the light emitted by the illumination device 4 may be greater than 550 nm, or may be greater than 600 nm.

Adjusting element 18 may be operable to control the color temperature of the light emitted by the illumination device 4 so that the color temperature is less than 2,000 K, less than 1,800 K, or less than 1,500 K.

The method of the present invention for illuminating cryostat chamber 2 of cryostat 1 is performed using illumination device 4, and is suitable, in particular, for use in frozen section microautoradiography.

In order to avoid opening of cryostat 2 during processing, a slide coated with a suitable photographic emulsion as a photosensitive element for producing the autoradiographic image is advantageously introduced simultaneously with the tissue of interest. Conventionally, therefore, the entire process would have to be carried out under impaired visual conditions. However, in the embodiment of the present invention presented here, illumination device 4 is adjusted via circuit means 10 prior to introduction of the slide and the tissue in such a way that it emits only light of one or more wavelengths to which the photographic emulsion used is not sensitive. As a result, the process can be carried out within cryostat chamber 2 under adequate visual conditions.

The tissue labeled with radioactive substances is frozen and cut using microtome 3, so that a thin tissue slice (of a few microns in thickness) is obtained. This tissue slice is then placed on the slide. At this point, the processing within cryostat chamber 2 typically ends. The present invention significantly simplifies, in particular, the cutting of the tissue and the mounting of the tissue section on the slide.

The slide is then removed, exposed for a certain period of time, and finally developed.

What is claimed is:

1. A cryostat (1) comprising:
a cryostat chamber (2);
a microtome (3) contained in the cryostat chamber (2), the microtome (3) being operable to cut frozen specimens; and
an illumination device (4) contained in the cryostat chamber (2) for illuminating the cryostat chamber (2);
wherein the illumination device (4) provides safelight illumination.

2. The cryostat (1) as recited in claim 1, wherein the illumination device (4) is adapted to emit light of at least one wavelength to which a photosensitive element accommodated in the cryostat chamber (2) is not sensitive.

3. The cryostat (1) as recited in claim 2, further comprising an adjusting element (18) operable to select at least one wavelength or wavelength range and/or a color temperature of the light emitted by the illumination device (4).

4. The cryostat (1) as recited in claim 2, wherein all wavelengths of the light emitted by the illumination device (4) are greater than 500 nm.

5. The cryostat (1) as recited in claim 4, wherein all wavelengths of the light emitted by the illumination device (4) are in a range from 500 nm through 550 nm.

6. The cryostat (1) as recited in claim 4, wherein all wavelengths of the light emitted by the illumination device (4) are greater than 550 nm.

7. The cryostat (1) as recited in claim 6, wherein all wavelengths of the light emitted by the illumination device (4) are greater than 600 nm.

8. The cryostat (1) as recited in claim 3, wherein the color temperature of the light emitted by the illumination device (4) is less than 2,000 K.

9. The cryostat (1) as recited in claim 8, wherein the color temperature of the light emitted by the illumination device (4) is less than 1,800 K.

10. The cryostat (1) as recited in claim 9, wherein the color temperature of the light emitted by the illumination device (4) is less than 1,500 K.

11. The cryostat (1) as recited in claim 1, wherein the illumination device (4) includes at least one LED (5).

12. The cryostat (1) as recited in claim 11, wherein the illumination device (4) includes a plurality of LEDs (5) grouped together into an illumination module (6).

13. A method for illuminating a cryostat chamber (2) of a cryostat (1) using an illumination device (4), wherein the cryostat chamber (2) contains a microtome (3) for cutting frozen specimens and contains the illumination device (4), the method comprising the steps of:
accommodating a photosensitive element in the cryostat chamber (2) for producing an autoradiographic image; and
operating the illumination device (4) such that it emits only light of at least one wavelength or wavelength range to which the photosensitive element is not sensitive.

14. The method as recited in claim 13, wherein at least one wavelength or wavelength range and/or the color temperature of the light emitted by the illumination device (4) is selected using an adjusting element (18).

15. The method as recited in claim 13, wherein the photosensitive element is a slide coated with photographic emulsion or a film.

16. The method as recited in claim 13, wherein the method is carried out in a cryostat (1) according to claim 1.

17. The method as recited in claim 15, wherein the method is carried out in a cryostat according to claim 3.
